(19) United States
(12) Patent Application Publication
(10) Pub. No.: US 2021/0146406 A1
(43) Pub. Date: May 20, 2021

(54) CLEANING APPARATUS FOR SENSOR

(71) Applicants: Ford Global Technologies, LLC, Dearborn, MI (US); Valeo North America, Inc., Auburn Hills, MI (US)

(72) Inventors: Andre Sykula, Sterling Heights, MI (US); Rashaun Phinisee, Ypsilanti, MI (US); Venkatesh Krishnan, Canton, MI (US); Kunal Singh, Farmington Hills, MI (US); Raghuraman Surineedi, Dearborn, MI (US); Michael Whitney, Auburn Hills, MI (US); David Franco, Issoire (FR); Robin Moulart, Auburn Hills, MI (US); William Terrasse, Issoire (FR)

(73) Assignees: Ford Global Technologies, LLC, Dearborn, MI (US); Valeo North America, Inc., Auburn Hills, MI (US)

(21) Appl. No.: 16/686,494

(22) Filed: Nov. 18, 2019

(51) Int. Cl. B08B 3/02; G01S 7/481

(52) U.S. Cl. CPC B08B 3/024; G01S 7/4811

(57) ABSTRACT

A sensor apparatus includes a cylindrical sensor window defining an axis, and a plurality of at least three tubular segments fixed relative to the sensor window. Each tubular segment is elongated circumferentially relative to the axis. The tubular segments collectively form a ring substantially centered around the axis. Each tubular segment includes at least one first nozzle and at least one second nozzle. The first nozzles and second nozzles are arranged in an alternating pattern around the ring. The first nozzles each have a direction of discharge in a radially inward and axial direction forming a first angle with the axis, and the second nozzles each have a direction of discharge in a radially inward and axial direction forming a second angle with the axis, the second angle being different than the first angle.

### BACKGROUND

Autonomous vehicles typically include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. When sensor lenses, covers, and the like become dirty, smudged, etc., sensor operation can be impaired or precluded.

### BRIEF DESCRIPTION OF THE DRAWINGS

FIG. 1 is a perspective view of an example vehicle.

FIG. 2 is an exploded perspective view of a sensor apparatus of the vehicle.

FIG. 3 is a perspective view of a portion of the sensor apparatus.

FIG. 4 is a diagram of an example sensor-cleaning system of the vehicle.

FIG. 5 is a cross-sectional perspective view of a portion of the sensor apparatus.

FIG. 6 is an exploded perspective view of a tubular segment of the sensor apparatus.

FIG. 7 is a perspective view of the tubular segments of the sensor apparatus.

FIG. 8 is a top view of a portion of the sensor apparatus.

FIG. 9A is a cross-sectional view of an example first nozzle of the tubular segments.

FIG. 9B is a cross-sectional view of an example second nozzle of the tubular segments.

FIG. 10 is a cross-sectional perspective view of a portion of the sensor assembly.

FIG. 11 is a block diagram of an example control system for the sensor assembly.

FIG. 12 is a process flow diagram of an example process for controlling the sensor assembly.

### DETAILED DESCRIPTION

A sensor apparatus includes a cylindrical sensor window defining an axis and a plurality of at least three tubular segments fixed relative to the sensor window. Each tubular segment is elongated circumferentially relative to the axis. The tubular segments collectively form a ring substantially centered around the axis. Each tubular segment includes at least one first nozzle and at least one second nozzle. The first nozzles and second nozzles are arranged in an alternating pattern around the ring. The first nozzles each have a direction of discharge in a radially inward and axial direction forming a first angle with the axis. The second nozzles each have a direction of discharge in a radially inward and axial direction forming a second angle with the axis, and the second angle is different than the first angle.

Each tubular segment may be fluidly isolated from the other tubular segments. The sensor apparatus may further include a reservoir fluidly coupled to each tubular segment and a plurality of valves, and each valve may be actuatable to permit or block flow from the reservoir to a respective one of the tubular segments. Each valve may be actuatable independently of the others of the valves. The sensor apparatus may further include two pumps arranged in series to supply fluid from the reservoir to the tubular segments. The sensor apparatus may further include a computer in communication with the valves and with the pumps, and the computer may be programmed to activate one of the two pumps when the number of the valves that are open is below a threshold, and to activate both of the two pumps when the number of the valves that are open is at or above the threshold.

Each tubular segment may include a lower piece and an upper piece, each lower piece may define a channel extending circumferentially around the axis, and each upper piece may enclose the channel. The upper pieces may include the first nozzles and the second nozzles.

Each lower piece may include an inlet.

Each lower piece may include an air-nozzle surface extending vertically parallel to the axis and circumferentially around the axis and disposed radially inward relative to the axis from the channel. The sensor apparatus may further include a sensor housing including the sensor window, and the sensor housing and each air-nozzle surface may form an air nozzle. The air nozzles may be oriented to discharge parallel to the axis across the sensor window.

The first and second nozzles may be substantially evenly spaced around the ring.

The first and second nozzles may each include a flat deflection surface and an outlet directed at the respective deflection surface. The deflection surfaces of the first nozzles may each define the first angle with the axis, and the deflection surfaces of the second nozzles may each define the second angle with the axis.

The sensor apparatus further includes a sensor housing including the sensor window and a housing to which the sensor housing and the tubular segments are mounted.

With reference to the Figures, a sensor apparatus 32 for a vehicle 30 includes a cylindrical sensor window 34 defining an axis A, and a plurality of at least three tubular segments 36 fixed relative to the sensor window 34. Each tubular segment 36 is elongated circumferentially relative to the axis A. The tubular segments 36 collectively form a ring 38 substantially centered around the axis A. Each tubular segment 36 includes at least one first nozzle 40 and at least one second nozzle 42. The first nozzles 40 and second nozzles 42 are arranged in an alternating pattern around the ring 38. The first nozzles 40 each have a direction of discharge in a radially inward and axial direction forming a first angle θ with the axis A, and the second nozzles 42 each have a direction of discharge in a radially inward and axial direction forming a second angle φ with the axis A, the second angle φ being different than the first angle θ.

The sensor apparatus 32 provides good coverage when cleaning the sensor window 34. The different first angle θ and second angle φ provide cleaning coverage along a height of the sensor window 34. The sensor apparatus 32 has a robust design without moving parts for distributing fluid from the first nozzles 40 and second nozzles 42; i.e., the tubular segments 36, including the first nozzles 40 and second nozzles 42, have no moving parts. The sensor apparatus 32 uses fluid for cleaning in an efficient manner. Separating the fluid flow into the ring 38 into the separate tubular segments 36 can help equalize the velocity of fluid leaving the nozzles 40, 42.

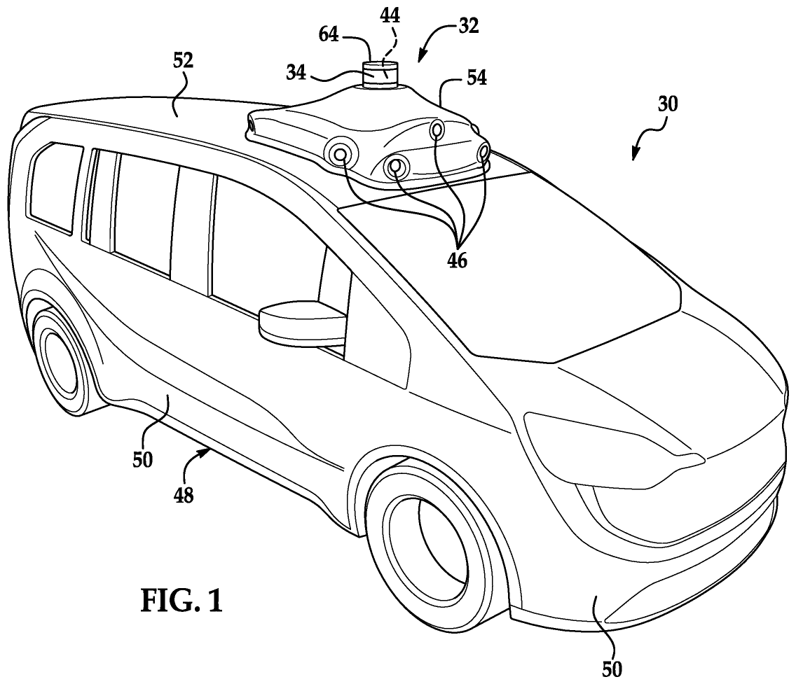

With reference to FIG. 1, the vehicle 30 may be any passenger or commercial automobile such as a car, a truck, a sport utility vehicle, a crossover, a van, a minivan, a taxi, a bus, etc.

The vehicle 30 may be an autonomous vehicle. A vehicle computer can be programmed to operate the vehicle 30 independently of the intervention of a human driver, completely or to a lesser degree. The vehicle computer may be programmed to operate a propulsion, brake system, steering, and/or other vehicle systems based at least in part on data received from a sensor 44 described below, as well as other sensors 46. For the purposes of this disclosure, autonomous operation means the vehicle computer controls the propulsion, brake system, and steering without input from a human driver; semi-autonomous operation means the vehicle computer controls one or two of the propulsion, brake system, and steering and a human driver controls the remainder; and nonautonomous operation means a human driver controls the propulsion, brake system, and steering.

The vehicle 30 includes a body 48. The vehicle 30 may be of a unibody construction, in which a frame and the body 48 of the vehicle 30 are a single component. The vehicle 30 may, alternatively, be of a body-on-frame construction, in which the frame supports the body 48 that is a separate component from the frame. The frame and body 48 may be formed of any suitable material, for example, steel, aluminum, etc.

The body 48 includes body panels 50 partially defining an exterior of the vehicle 30. The body panels 50 may present a class-A surface, e.g., a finished surface exposed to view by a customer and free of unaesthetic blemishes and defects. The body panels 50 include, e.g., a roof 52, etc.

A housing 54 for the sensor 44 and the other sensors 46 is attachable to the vehicle 30, e.g., to one of the body panels 50 of the vehicle 30, e.g., the roof 52. For example, the housing 54 may be shaped to be attachable to the roof 52, e.g., may have a shape matching a contour of the roof 52. The housing 54 may be attached to the roof 52, which can provide the sensor 44 and the other sensors 46 with an unobstructed field of view of an area around the vehicle 30. The housing 54 may be formed of, e.g., plastic or metal.

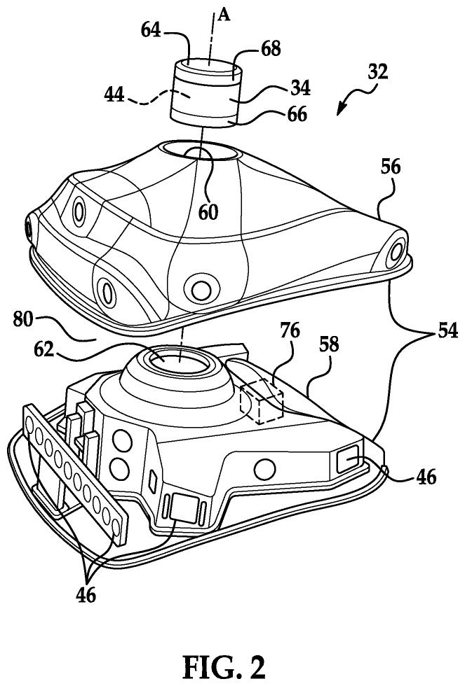

With reference to FIG. 2, the housing 54 includes a housing upper 56 and a housing lower 58. The housing upper 56 and the housing lower 58 are shaped to fit together, with the housing upper 56 fitting on top of the housing lower 58. The housing upper 56 covers the housing lower 58. The housing upper 56 includes a central opening 60 that exposes the housing lower 58. The central opening 60 is round, e.g., has a circular or slightly elliptical shape. The housing upper 56 and the housing lower 58 are each a single piece, i.e., are a continuous piece of material with no internal seams separating multiple pieces. For example, the housing upper 56 and the housing lower 58 may each be stamped or molded as a single piece. The housing lower 58 includes a bracket 62, a supporting panel 122, and a drainage channel 124 (described below), so the bracket 62, the supporting panel 122, and the drainage channel 124 are together a single piece.

The housing lower 58 includes the bracket 62 to which a sensor-housing bottom 66 of a sensor housing 64 is mounted. The sensor housing 64 is supported by and mounted to the housing 54, specifically the housing lower 58. The sensor housing 64 can be disposed on top of the housing 54 at a highest point of the housing 54. The bracket 62 is shaped to accept and fix in place the sensor-housing bottom 66 of the sensor housing 64, e.g., with a press fit or snap fit. The bracket 62 defines an orientation and position of the sensor housing 64 relative to the vehicle 30.

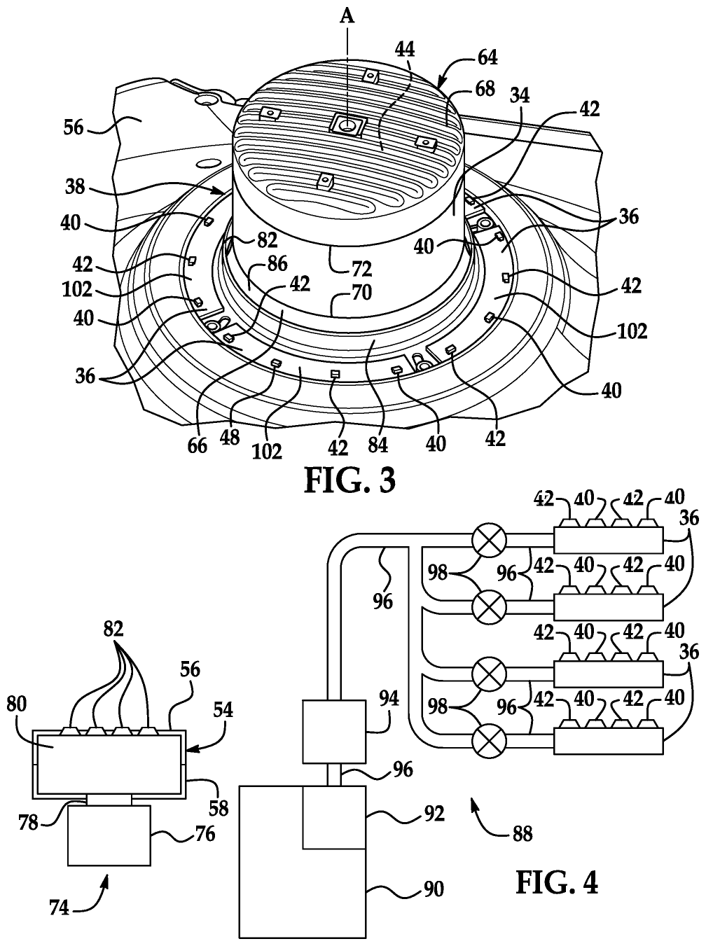

With reference to FIG. 3, the sensor housing 64 has a cylindrical shape and defines an axis A. The sensor housing 64 extends vertically upward along the axis A from the sensor-housing bottom 66. The sensor housing 64 includes a sensor-housing top 68, the sensor window 34, and the sensor-housing bottom 66. The sensor-housing top 68 is disposed directly above the sensor window 34, and the sensor-housing bottom 66 is disposed directly below the sensor window 34. The sensor-housing top 68 and the sensor-housing bottom 66 are vertically spaced apart by a height of the sensor window 34.

The sensor 44 is disposed inside the sensor housing 64 and is attached to and supported by the housing 54. The sensor 44 may be designed to detect features of the outside world; for example, the sensor 44 may be a radar sensor, a scanning laser range finder, a light detection and ranging (LIDAR) device, or an image processing sensor such as a camera. In particular, the sensor 44 may be a LIDAR device, e.g., a scanning LIDAR device. A LIDAR device detects distances to objects by emitting laser pulses at a particular wavelength and measuring the time of flight for the pulse to travel to the object and back.

The sensor window 34 is cylindrical and defines the axis A, which is oriented substantially vertically. The sensor window 34 extends around the axis A. The sensor window 34 can extend fully around the axis A, i.e., 360°, or partially around the axis A. The sensor window 34 extends along the axis A from a bottom edge 70 to a top edge 72. The bottom edge 70 contacts the sensor-housing bottom 66, and the top edge 72 contacts the sensor-housing top 68. The sensor window 34 is positioned above the tubular segments 36, e.g., the bottom edge 70 of the sensor window 34 is above the tubular segments 36. The outer diameter of the sensor window 34 may be the same as the outer diameters of the sensor-housing top 68 and/or the sensor-housing bottom 66; in other words, the sensor window 34 may be flush or substantially flush with the sensor-housing top 68 and/or the sensor-housing bottom 66. “Substantially flush” means a seam between the sensor window 34 and the sensor-housing top 68 or sensor-housing bottom 66 does not cause turbulence in air flowing along the sensor window 34. At least some of the sensor window 34 is transparent with respect to whatever medium the sensor 44 is capable of detecting. For example, if the sensor 44 is a LIDAR device, then the sensor window 34 is transparent with respect to visible light at the wavelengths generated by the sensor 44.

The tubular segments 36 are fixed relative to the sensor window 34. For example, the tubular segments 36 can be mounted to the housing 54, e.g., bolted to the housing lower 58, to which the sensor housing 64 including the sensor window 34 is mounted. The tubular segments 36 can be directly attached to each other, or the tubular segments 36 can be attached to each other indirectly via the housing 54, e.g., the housing lower 58.

Each tubular segment 36 is elongated circumferentially around the axis A. The tubular segments 36 include at least three tubular segments 36; for example, as shown in the Figures, the tubular segments 36 include four tubular segments 36. Each tubular segment 36 can have substantially the same circumferential elongation around the axis A, e.g., 90°. The tubular segments 36 collectively form a ring 38 substantially centered around the axis A. The circumferential elongation of the tubular segments 36 can sum to 360°, e.g., four tubular segments 36 of 90°.

With reference to FIG. 4, an air cleaning system 74 includes a compressor 76, a filter 78, a chamber 80, and air nozzles 82. The compressor 76, the filter 78, and the air nozzles 82 are fluidly connected to each other (i.e., fluid can flow from one to the other) in sequence through the chamber 80.

The compressor 76 increases the pressure of a gas by, e.g., forcing additional gas into a constant volume. The compressor 76 may be any suitable type of compressor, e.g., a positive-displacement compressor such as a reciprocating, ionic liquid piston, rotary screw, rotary vane, rolling piston, scroll, or diaphragm compressor; a dynamic compressor such as an air bubble, centrifugal, diagonal, mixed-flow, or axial-flow compressor; or any other suitable type.

The filter 78 removes solid particulates such as dust, pollen, mold, dust, and bacteria from air flowing through the filter 78. The filter 78 may be any suitable type of filter, e.g., paper, foam, cotton, stainless steel, oil bath, etc.

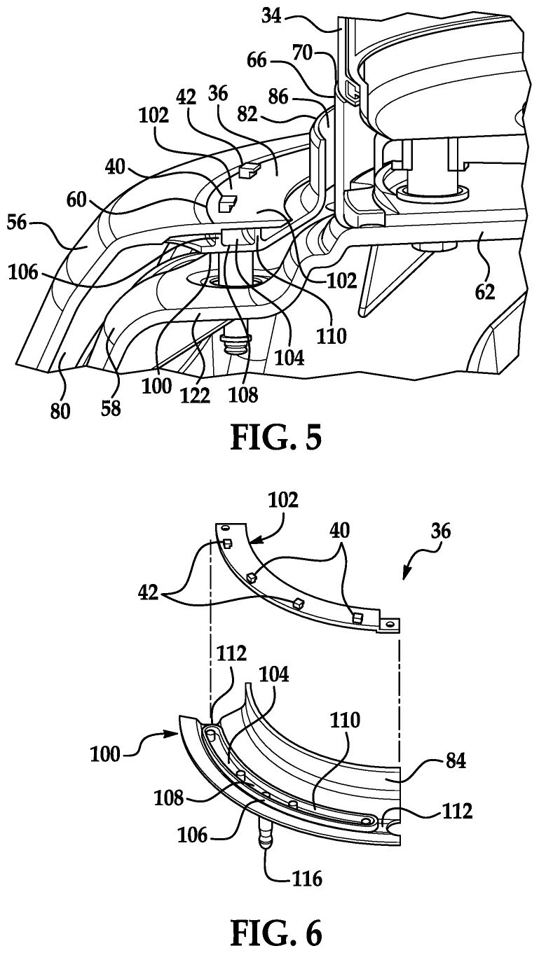

With reference to FIG. 5, the housing upper 56 and the housing lower 58 form the chamber 80 by enclosing a space between the housing upper 56 and the housing lower 58. The compressor 76 can be positioned to pressurize the chamber 80, i.e., positioned to draw in air from outside the housing 54 and output air into the chamber 80.

The air nozzles 82 are positioned to receive pressurized air from the chamber 80 and discharge that air across the sensor window 34. The air nozzles 82 are oriented to discharge parallel to the axis A across the sensor window 34 from below the sensor window 34. The air nozzles 82 are formed of the sensor housing 64 and the tubular segments 36, specifically of the sensor-housing bottom 66 of the sensor housing 64 and of air-nozzle surfaces 84 of the tubular segment 36. Each tubular segment 36 includes one air-nozzle surface 84. The air-nozzle surfaces 84 are curved plates of substantially constant thickness. Each air-nozzle surface 84 extends vertically parallel to the axis A and circumferentially around the axis A at a substantially constant radius from the axis A. The direction of the thickness is orthogonal to the vertical and circumferential directions of extension of the air-nozzle surface 84. Pressurized air from the chamber 80 is directed vertically upward through a gap 86 formed between the sensor-housing bottom 66 and the air-nozzle surfaces 84.

Returning to FIG. 4, a liquid cleaning system 88 of the vehicle 30 includes a reservoir 90, a first pump 92, a second pump 94, liquid supply lines 96, valves 98, the tubular segments 36, the first nozzles 40, and the second nozzles 42. The reservoir 90 and the pumps 92, 94 are fluidly connected (i.e., fluid can flow from one to the other) to each valve 98, to each tubular segment 36, and thus to the first nozzles 40 and second nozzles 42. The liquid cleaning system 88 distributes washer fluid stored in the reservoir 90 to the first nozzles 40 and second nozzles 42. “Washer fluid” refers to any liquid stored in the reservoir 90 for cleaning. The washer fluid may include solvents, detergents, diluents such as water, etc.

The reservoir 90 may be a tank fillable with liquid, e.g., washer fluid for window cleaning. The reservoir 90 may be disposed in a front of the vehicle 30, specifically, in an engine compartment forward of a passenger cabin. Alternatively, the reservoir 90 may be disposed in the housing 54, e.g., in the chamber 80 or below the housing lower 58. The reservoir 90 may store the washer fluid only for supplying the sensor apparatus 32 or also for other purposes, such as supply to the windshield.

The pumps 92, 94 force the washer fluid through the liquid supply lines 96 to the valves 98 and then to the first nozzles 40 and second nozzles 42 with sufficient pressure that the washer fluid sprays from the first nozzles 40 and second nozzles 42. The pumps 92, 94 are fluidly connected to the reservoir 90. The pumps 92, 94 may be attached to or disposed in the reservoir 90. For example, the first pump 92 can be located in the reservoir 90, and the second pump 94 can be spaced from the reservoir 90. The pumps 92, 94 are arranged in series to supply washer fluid from the reservoir 90 to the valves 98 and then to the tubular segments 36. In other words, one of the pumps 92, 94 discharges fluid to the other of the pumps 92, 94, which in turn discharges the received fluid. Arranging the pumps 92, 94 in series can provide a greater pressure rise than other arrangements of the pumps 92, 94, e.g., in parallel.

The liquid supply lines 96 can extend from the first pump 92 to the second pump 94, from the second pump 94 to the valves 98, and from the valves 98 to the tubular segments 36. A separate liquid supply line extends from each valve 98 to the respective tubular segment 36. The liquid supply lines 96 may be, e.g., flexible tubes.

The valves 98 are independently actuatable to open and close, to permit the washer fluid to flow through or to block the washer fluid; i.e., each valve 98 can be opened or closed without changing the status of the other valves 98. Each valve 98 is positioned to permit or block flow from the reservoir 90 to a respective one of the tubular segments 36. The valves 98 may be any suitable type of valve, e.g., ball valve, butterfly valve, choke valve, gate valve, globe valve, etc.

With reference to FIG. 6, each tubular segment 36 includes a lower piece 100 and an upper piece 102. Each lower piece 100 defines a channel 104 extending circumferentially around the axis A with the respective tubular segment 36. Specifically, each channel 104 has a substantially constant cross-section along an arc extending circumferentially around the axis A. The cross-section of each channel 104 includes a radially outer side wall 106, a floor 108, and a radially inner side wall 110, as shown in FIG. 5. The floor 108 extends horizontally, the radially outer side wall 106 extends vertically from a radially outer edge of the floor 108, and the radially inner side wall 110 extends vertically from a radially inner edge of the floor 108. Each lower piece 100 includes two end walls 112. Each channel 104 extends circumferentially around the axis A from one end wall 112 of that lower piece 100 to the other end wall 112 of that lower piece 100. Each lower piece 100 includes one of the air-nozzle surfaces 84. The air-nozzle surfaces 84 are each disposed radially inward relative to the axis A from the channel 104.

Each upper piece 102 of the respective tubular segment 36 encloses the respective channel 104 of the lower piece 100 of that tubular segment 36. Each upper piece 102 extends circumferentially around the axis A with the channel 104 from one end wall 112 to the other end wall 112 of the respective lower piece 100, and each upper piece 102 extends radially outward from the radially inner side wall 110 to the radially outer side wall 106 of the respective lower piece 100. The upper pieces 102 include the first nozzles 40 and the second nozzles 42.

Returning to FIG. 5, each tubular segment 36 includes a cavity 114 enclosed by the upper piece 102 and the channel 104 and end walls 112 of the lower piece 100. Each tubular segment 36 is fluidly isolated form the other tubular segments 36. In other words, the cavities 114 of the tubular segments 36 are fluidly isolated from each other; i.e., the cavities 114 are arranged such that fluid cannot flow from one to the other. The cavities 114 are sealed other than the first nozzles 40, the second nozzles 42, and inlets 116.

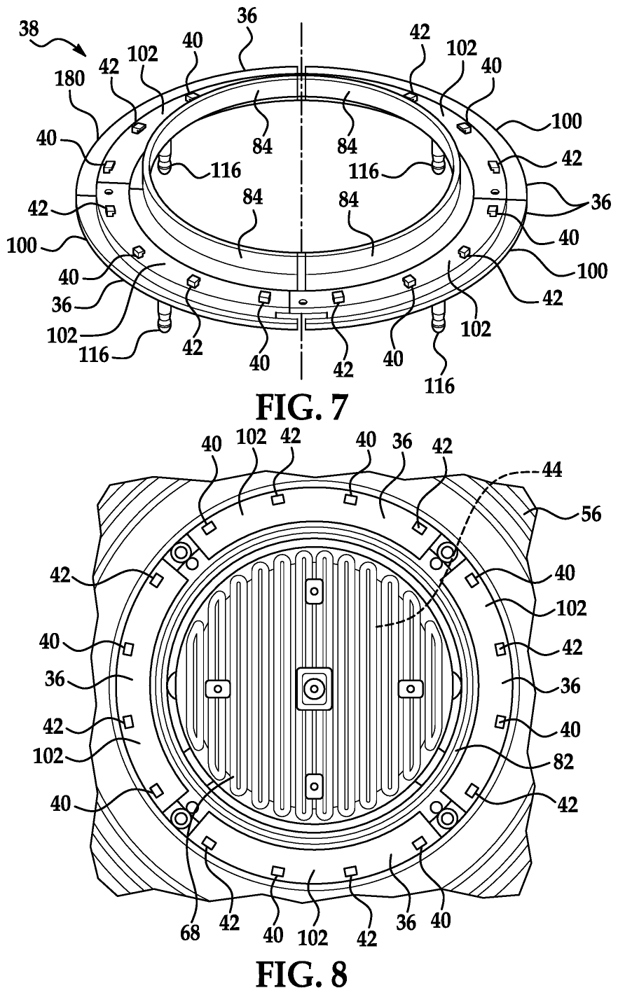

With reference to FIG. 7, each lower piece 100 includes an inlet 116. The reservoir 90 is fluidly coupled to each tubular segment 36, i.e., to each cavity 114, via the respective inlet 116. The inlets 116 extend downward from the respective lower pieces 100. Each inlet 116 may be disposed approximately halfway along the circumferential elongation of the respective lower piece 100; e.g., if the lower piece 100 has a circumferential elongation of 90°, the inlet 116 is approximately 45° from either end of the lower piece 100.

With reference to FIG. 8, each tubular segment 36 includes at least one first nozzle 40 and at least one second nozzle 42. The first nozzles 40 and the second nozzles 42 are arranged in an alternating pattern around the ring 38 formed of the tubular segments 36; i.e., each first nozzle 40 is circumferentially adjacent to one second nozzle 42 in each direction, and each second nozzle 42 is circumferentially adjacent to one first nozzle 40 in each direction. The first nozzles 40 and second nozzles 42 are substantially evenly spaced around the ring 38; i.e., the distance from each first or second nozzle 40, 42 to the adjacent first or second nozzle 40, 42 is substantially the same. The first nozzles 40 can include eight first nozzles 40, and the second nozzles 42 can include eight second nozzles 42. The first nozzles 40 and the second nozzles 42 can be evenly divided among the tubular segments 36; e.g., with four tubular segments 36, each tubular segment 36 includes two first nozzles 40 and two second nozzles 42.

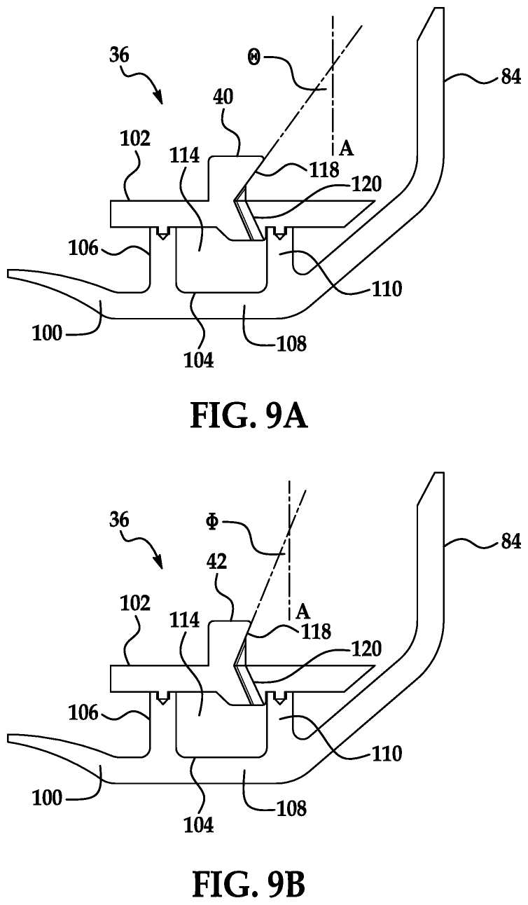

With reference to FIGS. 9A-B, the first nozzles 40 and second nozzles 42 are liquid nozzles. The first nozzles 40 and second nozzles 42 are shaped to spray fluid in a flat-fan pattern. The first nozzles 40 and second nozzles 42 each include a deflection surface 118, which is flat, and an outlet 120 directed at the respective deflection surface 118. Fluid exiting one of the cavities 114 through one of the outlets 120 hits the respective deflection surface 118 and spreads out into the flat-fan pattern defined by the deflection surface 118.

The first nozzles 40 each have a direction of discharge in a radially inward and axial direction, i.e., a direction that is toward the axis A and along the axis A, forming the first angle θ with the axis A. The second nozzles 42 each have a direction of discharge in a radially inward and axial direction forming the second angle φ with the axis A. The second angle φ is different than the first angle θ. The deflection surfaces 118 of the first nozzles 40 each define the first angle θ with the axis A, and the deflection surfaces 118 of the second nozzles 42 each define the second angle φ with the axis A.

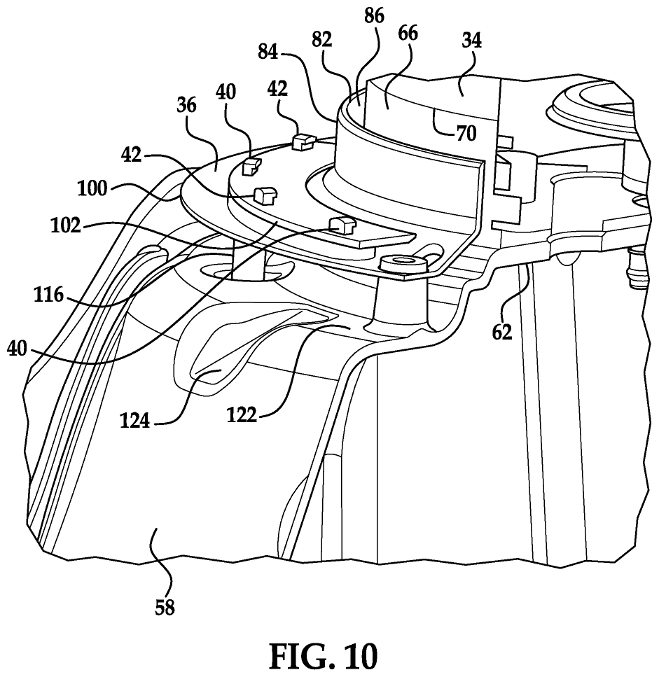

With reference to FIG. 10, the housing lower 58 includes a supporting panel 122 positioned directly below the tubular segments 36. The supporting panel 122 extends radially outward from the bracket 62. The supporting panel 122 is generally horizontal. The housing lower 58 includes a drainage channel 124. The drainage channel 124 extends into the supporting panel 122, i.e., extends radially inward from an outer circumference of the supporting panel 122, and the drainage channel 124 slopes downward in a radially outward direction. The drainage channel 124 can help drain fluid that flows through the gap 86 into the chamber 80.

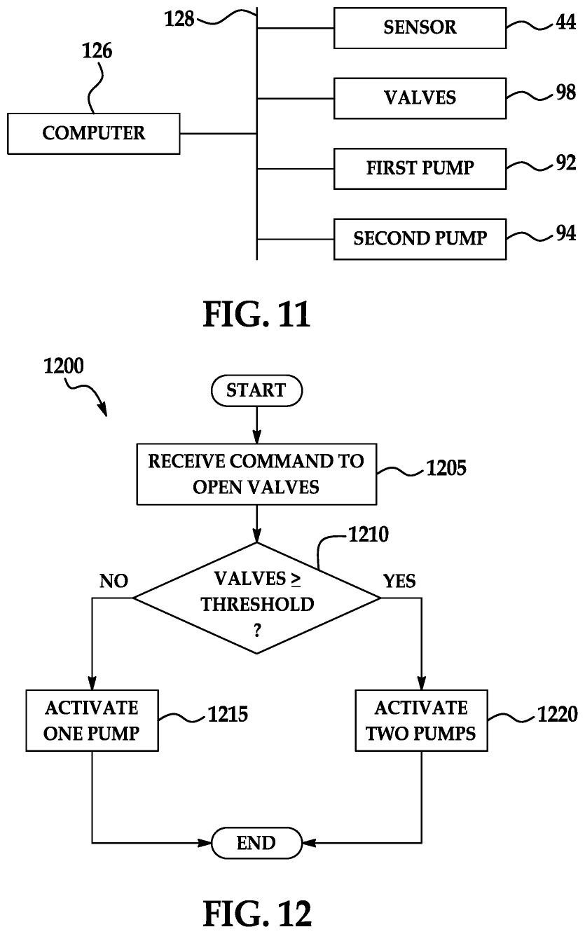

With reference to FIG. 11, the vehicle 30 includes a computer 126. The computer 126 is a microprocessor-based computing device, e.g., an electronic controller or the like. The computer 126 includes a processor, a memory, etc. The memory of the computer 126 includes media for storing instructions executable by the processor as well as for electronically storing data and/or databases.

The computer 126 may transmit and receive data through a communications network 128 such as a controller area network (CAN) bus, Ethernet, WiFi, Local Interconnect Network (LIN), onboard diagnostics connector (OBD-II), and/or by any other wired or wireless communications network. The computer 126 may be communicatively coupled to the sensor 44, the valves 98, the pumps 92, 94, and other components via the communications network 128.

FIG. 12 is a process flow diagram illustrating an exemplary process 1200 for controlling the sensor apparatus 32. The memory of the computer 126 stores executable instructions for performing the steps of the process 1200. As a general overview of the process 1200, the computer 126 receives a command to clean a portion of the sensor window 34 that includes a number of the valves 98 that will be open, and the computer 126 selects whether to activate one of the pumps 92, 94 or both pumps 92, 94 based on whether the number of open valves 98 is at least a threshold value.

The process 1200 begins in a block 1205, in which the computer 126 receives a command to clean the sensor window 34. The command will include which of the valves 98 will be open, and the computer 126 can count the number of the valves 98 that will be open. For example, the computer 126 may issue a command to clean an obstructed portion of the sensor window 34 that is centered above one of the tubular segments 36 that includes opening the valve 98 leading to that tubular segment 36 and leaving the rest of the valves 98 closed; in this case, one valve 98 is open. For another example, the computer 126 may issue a command to clean an obstructed portion of the sensor window 34 that is directly above where two of the tubular segments 36 meet and that includes opening the valves 98 leading to those two tubular segments 36 and leaving the other two valves 98 closed; in this case, two valves 98 are open. For another example, the computer 126 may issue a command to clean the entirety of the sensor window 34 that includes opening all the valves 98; in this case, four valves 98 are open. For another example, the computer 126 may issue a command to clean all of the sensor window 34 that is at least partially forward facing; in this case, three valves 98 can be open.

Next, in a decision block 1210, the computer 126 determines whether the number of valves 98 that are open is at or above a threshold, or whether the number is below the threshold. The threshold can be chosen based on the pressure that the pumps 92, 94 are able to deliver when different numbers of valves 98 are open. For example, if one of the pumps 92, 94 is capable of supplying sufficient pressure to clean the sensor window 34 for up to six first or second nozzles 40, 42, then the threshold is two valves 98 (and the computer 126 will only issue commands to open up to three valves 98 at a time, not all four valves 98). If the number of open valves 98 is below the threshold, e.g., is one when the threshold is two, the process 1200 proceeds to a block 1215. If the number of open valves 98 is at or above the threshold, e.g., is two or three when the threshold is two, the process 1200 proceeds to a block 1220.

In the block 1215, the computer 126 activates one of the two pumps 92, 94, e.g., the first pump 92, while maintaining the other pump 92, 94, e.g., the second pump 94, as inactive. Activating one of the pumps 92, 94 is coordinated with opening the selected valve or valves 98, e.g., is performed substantially simultaneously. The first pump 92 can be activated for a preset duration and then deactivated. After the block 1215, the process 1200 ends.

In the block 1220, the computer 126 activates both of the two pumps 92, 94. Activating the pumps 92, 94 is coordinated with opening the selected valve or valves 98, e.g., is performed substantially simultaneously. The pumps 92, 94 can be activated for a preset duration and then deactivated. After the block 1220, the process 1200 ends.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. “Substantially” as used herein means that a dimension, time duration, shape, or other adjective may vary slightly from what is described due to physical imperfections, power interruptions, variations in machining or other manufacturing, etc. Many modifications and variations of the present disclosure are possible in light of the above teachings, and the disclosure may be practiced otherwise than as specifically described.

What is claimed is:

1. A sensor apparatus comprising:
a cylindrical sensor window defining an axis; and
a plurality of at least three tubular segments fixed relative to the sensor window, each tubular segment elongated circumferentially relative to the axis;
wherein the tubular segments collectively form a ring substantially centered around the axis;
each tubular segment includes at least one first nozzle and at least one second nozzle;
the first nozzles and second nozzles are arranged in an alternating pattern around the ring;
the first nozzles each have a direction of discharge in a radially inward and axial direction forming a first angle with the axis; and
the second nozzles each have a direction of discharge in a radially inward and axial direction forming a second angle with the axis, the second angle being different than the first angle.

2. The sensor apparatus of claim 1, wherein each tubular segment is fluidly isolated from the other tubular segments.

3. The sensor apparatus of claim 2, further comprising a reservoir fluidly coupled to each tubular segment, and a plurality of valves, wherein each valve is actuatable to permit or block flow from the reservoir to a respective one of the tubular segments.

4. The sensor apparatus of claim 3, wherein each valve is actuatable independently of the others of the valves.

5. The sensor apparatus of claim 4, further comprising two pumps arranged in series to supply fluid from the reservoir to the tubular segments.

6. The sensor apparatus of claim 5, further comprising a computer in communication with the valves and with the pumps, wherein the computer is programmed to activate one of the two pumps when the number of the valves that are open is below a threshold, and to activate both of the two pumps when the number of the valves that are open is at or above the threshold.

7. The sensor apparatus of claim 1, wherein each tubular segment includes a lower piece and an upper piece, each lower piece defines a channel extending circumferentially around the axis, and each upper piece encloses the channel.

8. The sensor apparatus of claim 7, wherein the upper pieces include the first nozzles and the second nozzles.

9. The sensor apparatus of claim 7, wherein each lower piece includes an inlet.

10. The sensor apparatus of claim 7, wherein each lower piece includes an air-nozzle surface extending vertically parallel to the axis and circumferentially around the axis and disposed radially inward relative to the axis from the channel.

11. The sensor apparatus of claim 10, further comprising a sensor housing including the sensor window, wherein the sensor housing and each air-nozzle surface form an air nozzle.

12. The sensor apparatus of claim 11, wherein the air nozzles are oriented to discharge parallel to the axis across the sensor window.

13. The sensor apparatus of claim 1, wherein the first and second nozzles are substantially evenly spaced around the ring.

14. The sensor apparatus of claim 1, wherein the first and second nozzles are shaped to spray fluid in a flat-fan pattern.

15. The sensor apparatus of claim 1, wherein the first and second nozzles each include a flat deflection surface and an outlet directed at the respective deflection surface.

16. The sensor apparatus of claim 15, wherein the deflection surfaces of the first nozzles each define the first angle with the axis, and the deflection surfaces of the second nozzles each define the second angle with the axis.

17. The sensor apparatus of claim 1, further comprising a sensor housing including the sensor window, and a housing to which the sensor housing and the tubular segments are mounted.
